(19) United States
(12) Patent Application Publication
(10) Pub. No.: US 2016/0193545 A1
(43) Pub. Date: Jul. 7, 2016

(54) Method and System for High-Efficiency Heat Energy Recycling Applicable to Plateau Areas Using a High-Temperature Concentrated Solar Thermal Collector

(71) Applicants: Binyuan ZHU, Guangzhou City (CN); Tibet Jinrui Asset Management Co., Ltd., Lhasa (CN); Guangzhou Ruishi Tianqi Energy Technology Co., Ltd, Guangzhou City (CN)

(72) Inventors: Binyuan ZHU, Guangzhou City (CN); Hao YU, Guangzhou City (CN); Rui ZHU, Guangzhou City (CN); Fuming PENG, Dongguan City (CN); Tailin WU, Dongguan City (CN)

(73) Assignees: Tibet Jinrui Asset Management Co., Ltd., Lhasa (CN); Guangzhou Ruishi Tianqi Energy Technology Co., Ltd, Guangzhou City (CN); Binyuan ZHU, Guangzhou (CN)

(21) Appl. No.: 15/067,812

(22) Filed: Mar. 11, 2016

Related U.S. Application Data
(62) Division of application No. 15/021,385, filed on Mar. 11, 2016.

(51) Int. Cl. B01D 9/00; C02F 1/04; B01D 5/00; C02F 1/14

(52) U.S. Cl. CPC B01D 9/0031; C02F 1/14; C02F 1/042; B01D 9/0059; B01D 5/006; B01D 5/0039; B01D 5/009; C02F 2303/10; B01D 2009/0086

(57) ABSTRACT

The invention discloses a high efficiency thermal energy recovery method and system, and a high temperature concentrated solar thermal collector. A concentrated solar photo-thermal device is used to heat heat-transfer oil to a high temperature and the oil is used for rapid heat replenishment for decompressing evaporation. Multiple methods are also used to recover thermal energy so as to recover a large part of thermal energy in a production process, thereby enabling the continuous production in plateau areas, reducing the electricity consumption, lowering the capacity of photovoltaic power stations, and reducing the fixed investment.

### RELATED APPLICATIONS

This application claims priority as a divisional of U.S. patent application Ser. No. 15/021,385, filed Mar. 11, 2016, titled “METHOD AND SYSTEM FOR PREPARING HIGH PURITY LITHIUM CARBONATE,” which is a 35 USC 371 national phase entry of PCT/CN2014/086344, filed Sep. 12, 2014, titled “HIGHLY EFFECTIVE THERMAL ENERGY RECOVERY METHOD AND SYSTEM, AND HIGH-PURITY LITHIUM CARBONATE PREPARATION METHOD AND SYSTEM BASED ON SAME,” the entire contents of which are incorporated herein by reference.

### TECHNICAL FIELD

The invention relates to a high-efficiency heat energy recycling method and system applicable to plateau areas, and more particularly, to remote plateau areas.

### BACKGROUND

In plateau areas, more particularly in remote plateau areas, the population generally is sparse, the temperature difference between the day and the night is large, infrastructures are weak, the traffic is inconvenient, and the water and electricity supply is seriously inadequate. But at the same time, vast mineral resources are also stored in the plateau areas to be developed.

Salt lakes in the plateau areas contain a variety of high-value mineral salts, such as lithium, potassium and other salts of strategic significance. But the content of the mineral salts in the salt lake is generally low, so that it is more difficult for large scale exploitation and utilization. Limited by adverse natural conditions, exploitation technologies in recent years mainly include salt lake water bay salt method, deposit exploitation method and the like, the bay salt method of which is the most environmentally-friendly exploitation method.

During the course of mining the mineral salts via the bay salt method, the processes of crystallization directly affect the mining efficiency. In general, the salt lake bittern is subjected to several processes such as bittern preparation, concentration, crystallization and the like, the production cycle lasts up to 10 months, and the production efficiency is low. Accelerating the crystallization of the mineral salts is beneficial for shortening the exploitation time and improving the yield.

The existing method for accelerating crystallization is mainly natural evaporation of a solar pond. The method is focused on utilizing the sunshine to increase the temperature of the bittern and accelerate the separation of the mineral salts. But the method seriously depends on the natural weather and is affected by the intensity of sunshine, wind and rain and other factors, has a certain limitation to improve the yield, and still does not change the condition of “living depending on the weather” fundamentally.

The solar energy is a clean energy and it is more abundant in sunny areas. The reasonable utilization of the solar energy is beneficial for solving a problem of energy shortage.

As the structure of a solar photo-thermal device is simple, the solar energy may be generally converted into heat energy only by a thermal collecting board. And the conversion efficiency is higher, up to above 60%. A variety of civil solar photo-thermal devices has been developed at present, such as various solar water heaters which have achieved good results.

According to the existing solar photo-thermal device, a medium may only be heated to no more than 100° C. generally, and the use in the areas where the altitude is low and the average temperature is higher may be met. However, the solar photo-thermal device is not applicable to the very cold and high-altitude areas, and furthermore, may not be applied to industrial production.

Currently, the lack of a solar photo-thermal device applicable to plateau areas potentially increases the difficulty to utilize the abundant solar energy in the plateau areas.

### SUMMARY

An object of the invention is to provide a high-efficiency heat energy recycling method and a high-efficiency heat energy recycling system applicable to plateau areas.

The invention adopts the technical solution as follows.

A high-efficiency heat energy recycling method includes the following steps:

1) utilizing a concentrated solar photo-thermal device to heat heat-transfer oil to more than 120° C. for standby application;
2) heating a liquid heat conducting medium in a water tank hot end and bittern in a preheating pool via the solar photo-thermal device, and guiding the preheated bittern into a temperature rising kettle;
3) absorbing heat from the cold end of the water tank via a high temperature heat pump, releasing heat to the temperature rising kettle via the hot end of the water tank, and heating the bittern in the temperature rising kettle to the temperature required;
4) guiding the bittern in the temperature rising kettle into a reaction kettle, applying a vacuum for decompressing concentration, guiding the heated heat-transfer oil into a heat exchanger in the reaction kettle to rapidly, additionally heat the reaction kettle, guiding the vapor produced by decompressing concentration in the reaction kettle into the heat exchanger in the preheating pool for cooling, and collecting the distilled water obtained into a distillate tank;
5) guiding the high temperature supernatant after crystallization in the reaction kettle into a cold end crystallization kettle via a pipeline, performing heat exchange between the cold end of the water tank and the cold end crystallization kettle via the heat exchanger, cooling the high temperature supernatant, and guiding the cooled and crystallized normal temperature or low temperature supernatant into a supernatant sedimentation tank;
6) heating the distilled water with the heat-transfer oil, scouring coarse crystallized salts in the reaction kettle, and guiding high temperature scouring liquor into a scouring liquor thermal insulation kettle; and
7) optionally, flushing the device and the pipeline of the system which are contacted with the bittern using the heated distilled water or the hot scouring liquor after sedimentation as necessary.

As a further improvement of the invention, the normal temperature scouring liquor is returned to the lake after recycling the heat energy in the scouring liquor.

As a further improvement of the invention, the liquid heat conducting medium at the cold end of the water tank and the hot end of the water tank is independently water or heat-transfer oil.

A high-efficiency heat energy recycling system applicable to plateau areas includes a preheating pool, a temperature rising kettle, a reaction kettle, a cold end crystallization kettle, a scouring liquor thermal insulation kettle and a supernatant sedimentation tank, wherein the preheating pool, the temperature rising kettle, the reaction kettle, the cold end crystallization kettle and a distillate tank are all provided with a heat exchanger, and the scouring liquid thermal insulation kettle is internally provided with a thermostat. The preheating pool is provided with a pipeline connecting to the temperature rising kettle, the temperature rising kettle is provided with a pipeline connecting to the reaction kettle, the reaction kettle is provided with a pipeline connecting to the cold end crystallization kettle and the scouring liquor thermal insulation kettle, and the cold end crystallization kettle is provided with a pipeline connecting to the supernatant sedimentation tank.

The system is further provided with a heat-transfer oil tank, which is connected with a concentrated solar photo-thermal device for heating heat-transfer oil, and a closed heat-transfer oil pipeline connecting to the heat exchanger in the reaction kettle and the heat exchanger in the distillate tank.

The hot end of the water tank and the preheating pool are connected with a solar photo-thermal device for supplying heat thereto.

A high temperature heat pump is arranged between the hot end of the water tank and the cold end of the water tank. The heat exchanger is arranged between the hot end of the water tank and the temperature rising kettle. The heat exchanger is arranged between the cold end of the water tank and the cold end crystallization kettle.

The reaction kettle is connected with a vacuum device, which is provided with a heat exchanger guiding vapor into the preheating pool and a pipeline extending to the distillate tank. The distillate tank is provided with a pipeline guiding the distilled water into the reaction kettle and the scouring liquor thermal insulating kettle.

As a further improvement of the invention, the preheating pool is comprises at least two preheating pools connected in series.

As a further improvement of the invention, the hot end of the water tank is connected with a heating device for supplying heat thereto in an auxiliary manner.

As a further improvement of the invention, the high temperature heat pump used in the above-mentioned system is provided with:

a multipoint thermal balance heat exchanger generating hot water via heat exchange, wherein the multipoint thermal balance heat exchanger is provided with a cold water input end, and hot water output from an output end is accessed to the hot end of the water tank through a water pump and a check valve;
a heat pump compressor, wherein coolants compressed and output by the heat pump compressor are provided for the multipoint thermal balance heat exchanger through an evaporator and a throttle in sequence, and the coolants are output from the multipoint thermal balance heat exchanger and then are inhaled by the heat pump compressor for circulation; and
the multipoint thermal balance heat exchanger is comprises a plurality of groups of heat exchangers connected in series, and a cross runner is arranged among various groups of heat exchangers.

As a further improvement of the invention, the hot water output end of the multipoint thermal balance heat exchanger is provided with a temperature control valve, and the output of the temperature control valve is connected with the water pump.

As a further improvement of the invention, a vapor-liquid separator is arranged between the heat pump compressor and the evaporator.

As a further improvement of the invention, the cold water input end of the multipoint thermal balance heat exchanger is provided with a dirt remover.

As a further improvement of the invention, the coolants used for the high temperature heat pump are ternary composite coolants with a mass ratio of R124:R245a:R22=3:3:1.

The high temperature concentrated solar thermal collector that is used by matching with the above-mentioned system or used independently includes a cambered concentrated light reflecting board and a support for fixing the light reflecting board, a light transmitting board is fixed on the front of the light reflecting board, end boards are arranged at both ends of the light reflecting board, the light reflecting board, the light transmitting board and the end boards jointly form a cavity, a collector pipe is arranged in the cavity along the parallel direction, and the collector pipe is internally provided with a liquid inlet and a liquid outlet.

As a further improvement of the invention, the collector pipe of the thermal collector is sheathed with a transparent thermal insulation pipe.

As a further improvement of the invention, the surface of the collector pipe of the thermal collector is black.

As a further improvement of the invention, the thermal insulation pipe of the thermal collector is a double-layer vacuum glass pipe.

As a further improvement of the invention, the surface of the collector pipe of the thermal collector is a matte surface.

As a further improvement of the invention, the support of the thermal collector is provided with a revolving shaft for regulating the light reflecting board to rotate.

As a further improvement of the invention, the revolving shaft of the thermal collector is provided with an angle gauge.

As a further improvement of the invention, the high temperature concentrated solar thermal collector in the thermal collector is provided with an actuator for driving the revolving shaft to rotate.

As a further improvement of the invention, the bottom of the light reflecting board in the thermal collector is provided with a liquid outlet.

As a further improvement of the invention, the surface of the light transmitting board of the thermal collector is provided with anti-static coating or a conducting layer.

The invention has the beneficial effects as follows:

The heat energy utilizing method according to the invention may recycle the heat energy efficiently and has a rapid heat exchange capability and a slow heat exchange capability as well, which meets different requirements of industrial production for heat, may be widely applied in various industrial production processes needing heating up and cooling, and more particularly, applicable to the extraction of mineral salts from salt lakes.

The heat energy utilizing system according to the invention may take full advantage of abundant sunshine in the plateau areas to efficiently recycle the heat energy, and supplies stable heat for production to meet the demands of production. At the same time, the system according to the invention may produce fresh water in a subsidiary manner, so as to further meet production and living needs.

The heat energy utilizing system according to the invention is reasonably designed, performs heat energy exchange by using liquid and heat pump to crystallize the bittern only in various kettles, and not to scale a bittern conveying pipeline. The bittern is rapidly, additionally heated by means of the high temperature heat-transfer oil, which may meet the heat quantity required when the water is mostly evaporated under a decompressed state and may achieve the standardization operation. The concentration and crystallization of a batch of bittern may be finished within about 1-2 hours with sunshine. The concentration and crystallization of a batch of bittern may be finished within about 10-30 minutes in a condition that the heat quantity is sufficient at noon, which greatly accelerates the concentration of the bittern, and facilitates the extraction of various mineral salts from the bittern. In this way, the production is more controllable and “living depending on the weather” is avoided.

Multi-level preheating pools are connected in series, so that the quantity of the bittern in each preheating pool is relatively reduced, which in combination with the heat exchange of countercurrent flow, facilitates the obtaining of the bittern at a higher temperature. At the same time, the heat exchange efficiency is improved and the demand for continuous production is met.

Compared to the situation that the liquid is heated by a resistance-type heater, the system according to the invention may increase twice to three times of heat quantity at the premise of the same power consumption, and recycles the vast majority of heat energy in the production process at the same time, which realizes the high-efficiency heat energy recycle in the plateau areas, greatly reduces the energy source as required for an industrialized extracting device in the plateau areas, so that the fixed investment quantity is greatly reduced, and it is green and environmentally-friendly.

The high temperature heat pump used in the heat energy utilizing system has high heat exchange efficiency. The temperature of the hot end of the water tank may be increased by 85° C. in the plateau areas via a first-level heat pump, so the heat exchange efficiency is high. At the same time, the heat pump is not directly contacted with the bittern with strong corrosive substance, so that the service life is long and stable operation may be performed.

The high temperature solar thermal collector according to the invention is wholly closed and has no air circulation with the outside, so that there is no convection heat loss, the photo-thermal conversion efficiency is high. A heat conducting medium may be heated up to above 200° C., which meets the demands of the special industrial production. It may be better applied to heat the other mediums, such as water, anti-freezing solution, heat-transfer oil and the like.

The high temperature solar thermal collector according to the invention is simple in structure, is easy to manufacture and is easy to integrally install, does not need to consider the construction effect of seasonally frozen ground, has a strong interchangeability, is convenient to maintain, may effectively withstand the aging of equipment and other harmful natural conditions caused by dust, high wind, rain, snow and ultraviolet ray, and more particularly applicable to the plateau areas.

### BRIEF DESCRIPTION OF THE DRAWINGS

FIG. 1 is a structural diagram of a heat recycling system according to the invention;

FIG. 2 is a structural diagram of a high temperature heat pump of a heat recycling system according to the invention;

FIG. 3 is a structural diagram of a multipoint thermal balance heat exchanger of a heat recycling system according to the invention; and

FIG. 4 and FIG. 5 are structural diagrams of a thermal collector according to the invention.

### DETAILED DESCRIPTION OF THE PREFERRED EMBODIMENTS

A high-efficiency heat energy recycling method includes the following steps.

1) a concentrated solar photo-thermal device is utilized to heat heat-transfer oil to more than 120° C. for standby;
2) a liquid heat conducting medium in a water tank hot end and bittern in a preheating pool is heated via the solar photo-thermal device, and the preheated bittern is guided into a temperature rising kettle;
3) heat is absorbed from the cold end of the water tank via a high temperature heat pump, the heat is released to the temperature rising kettle via the hot end of the water tank, and the bittern in the temperature rising kettle is heated up to the temperature required;
4) the bittern in the temperature rising kettle is guided into a reaction kettle, vacuumized for decompressed concentration, the heated heat-transfer oil is guided into a heat exchanger in the reaction kettle to rapidly, additionally heat the reaction kettle, vapor produced by decompressing concentration in the reaction kettle is guided into the heat exchanger in the preheating pool to cool, and distilled water obtained is collected into a distillate tank;
5) high temperature supernatant crystallized in the reaction kettle is guided into a cold end crystallization kettle via a pipeline, heat exchange is performed between the cold end of the water tank and the cold end crystallization kettle via the heat exchanger, the high temperature supernatant is cooled, and the cooled and crystallized normal temperature or low temperature supernatant is guided into a supernatant sedimentation tank;
6) the distilled water is heated with the heat-transfer oil, coarse crystallized salts are scoured in the reaction kettle, and high temperature scouring liquor is guided into a scouring liquor thermal insulation kettle; and
7) the system and the device and the pipeline contacted with the bittern are flushed by using the heated distilled water or sedimentated hot scouring liquor in necessity, and the normal temperature flushing liquor is returned to the lakes after recycling the heat energy in the flushing liquor.

In order to more rapidly supply heat, the heat-transfer oil is heated up to above 120° C. by using the concentrated solar photo-thermal device, preferably heated up to above 150° C., and more preferably, heated up to above 200° C.

The hot end of the water tank needs to exchange heat with the temperature rising kettle to heat the bittern in the temperature rising kettle, and the temperature of the liquid heat conducting medium is generally at 70-80° C. In order to obtain a better heating effect, the liquid heat conducting medium in the hot end of the water tank is required to have a higher temperature. The water has a lower cost, higher security and no contamination, but its boiling point is lower, whereas the heat-transfer oil has a higher cost, high boiling point and good security, but its specific heat capacity is lower. According to the specific application requirements, the liquid heat conducting medium may be selected from water or heat-transfer oil, or other liquid heat conducting medium.

The cold end of the water tank needs to exchange heat with the cold end crystallization kettle, and the medium temperature generally does not exceed 40° C. So selecting the water with high specific heat capacity, low cost and high safety as the heat conducting medium is more economical and practical. Of course, the heat-transfer oil or other liquid heat conducting medium may also be adopted if there are special requirements.

The heat energy recycling system according to the invention is further described with reference to the drawings hereinafter.

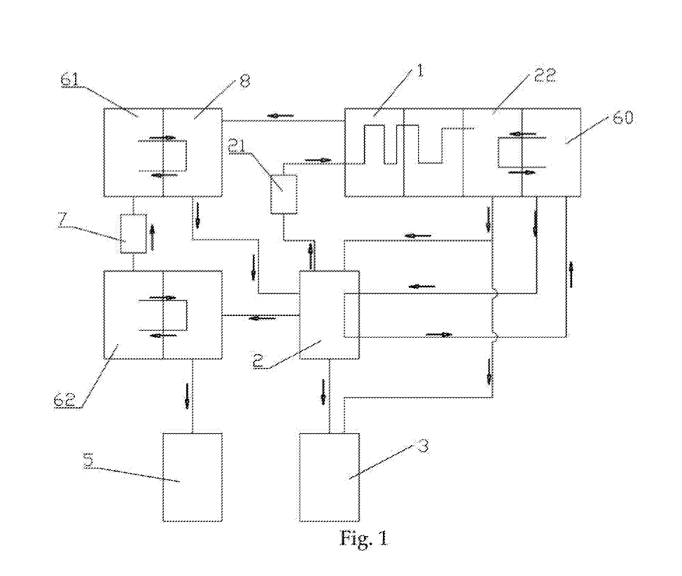

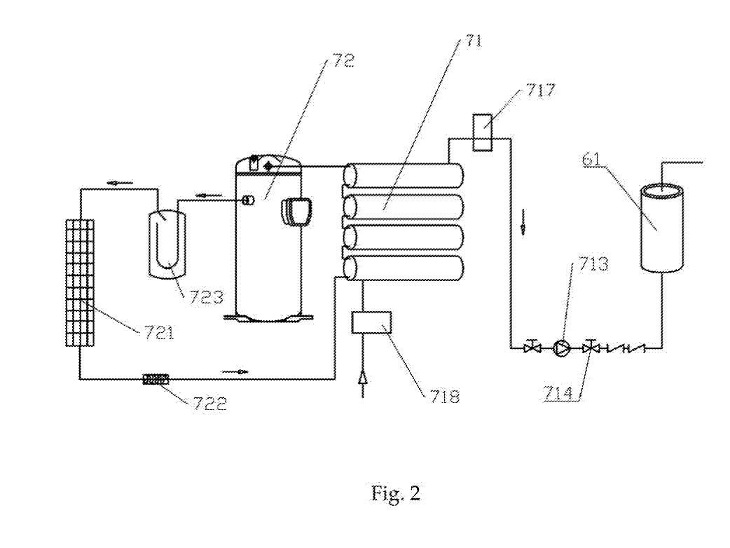

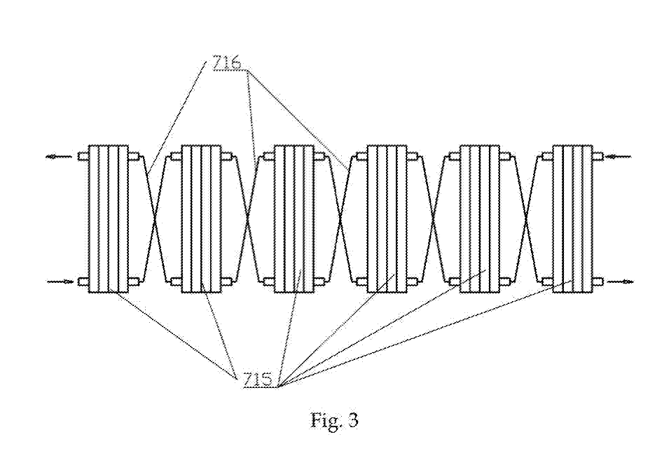

As shown in FIG. 1 to FIG. 3, a high-efficiency heat energy recycling system applicable to plateau areas includes a preheating pool 1, a temperature rising kettle 8, a reaction kettle 2, a cold end crystallization kettle 4, a thermal insulation kettle 3 for scouring liquor and a supernatant sedimentation tank 5, wherein the preheating pool 1, the temperature rising kettle 8, the reaction kettle 2 and the cold end crystallization kettle 4 are all provided with a heat exchanger, the thermal insulation kettle 3 for scouring liquid is internally provided with a thermostat; the preheating pool 1 is provided with a pipeline connecting to the temperature rising kettle 8, the temperature rising kettle 8 is provided with a pipeline connecting to the reaction kettle 2, the reaction kettle 2 is provided with a pipeline connecting to the cold end crystallization kettle 4 and the thermal insulation kettle 3 for scouring liquor, the cold end crystallization kettle 4 is provided with a pipeline connecting to the supernatant sedimentation tank 5.

The system is further provided with a heat-transfer oil tank 60, which is connected with a concentrated solar photo-thermal device for heating the heat-transfer oil, and a closed heat-transfer oil pipeline connecting to the heat exchanger in the reaction kettle and the heat exchanger in the distillate tank.

The hot end of the water tank 61 and the preheating pool 1 are connected with a solar photo-thermal device for supplying heat thereto.

A high temperature heat pump is arranged between the hot end of the water tank 61 and the cold end of the water tank 62, the heat exchanger is arranged between the hot end of the water tank 61 and the temperature rising kettle 1, and the heat exchanger is arranged between the cold end of the water tank 62 and the cold end crystallization kettle 4.

The reaction kettle 2 is connected with a vacuum device 21 which is provided with a heat exchanger guiding vapor into the preheating pool 1 and a pipeline extending to the distillate tank 22. The distillate tank 22 is provided with a pipeline guiding the distilled water into the heater and extending to the reaction kettle 2 and the thermal insulating kettle 3 for scouring liquor.

As a further improvement of the invention, the preheating pool comprises at least two preheating pools connected in series. Different preheating pools are relatively independent, which may heat the bittern accommodated therein step by step and ensure the bittern at the preheating terminal may more rapidly achieve the temperature required.

As a further improvement of the invention, the hot end of the water tank is connected with a heating device for supplying heat thereto in an auxiliary manner. The surplus electric power may be converted into the heat energy by using an auxiliary heating device, which steps up the production. At the same time, the scaling of the heating device caused by directly heating the bittern may also be avoided, which affects the heating efficiency.

As a further improvement of the invention, the high temperature heat pump 7 used in the above-mentioned system is provided with:

a multipoint thermal balance heat exchanger 71 generating hot water via heat exchange, wherein the multipoint thermal balance heat exchanger is provided with a cold water input end, and hot water output from an output end is accessed to the hot end of the water tank 61 through a water pump 713 and a check valve 714;
a heat pump compressor 72, wherein coolants compressed and output by the heat pump compressor are provided for the multipoint thermal balance heat exchanger 71 through an evaporator 721 and a throttle 722 in sequence, and the coolants are output from the multipoint thermal balance heat exchanger 71 and then are inhaled by the heat pump compressor 72 for circulation; and
the multipoint thermal balance heat exchanger 71 comprises a plurality of groups of heat exchangers 715 connected in series, and a cross runner 716 is arranged among various groups of heat exchangers 715.

As a further improvement of the invention, the hot water output end of the multipoint thermal balance heat exchanger 71 is provided with a temperature control valve 717, and the output of the temperature control valve 717 is connected with the water pump 713.

As a further improvement of the invention, a vapor-liquid separator 723 is arranged between the heat pump compressor 72 and the evaporator 721.

As a further improvement of the invention, the cold water input end of the multipoint thermal balance heat exchanger 71 is provided with a dirt remover 718.

As a further improvement of the invention, the coolants used for the high temperature heat pump are ternary composite coolants with a mass ratio of R124:R245a:R22=3:3:1. The discharge pressure of the composite coolant is 2.3-2.4 MPa, the back pressure is 0.2-0.3 MPa, the condensing temperature is 115-120° C., and the hot water temperature is ensured to be up to 85° C. at the altitude of 3,500-4,500 m, which meets the application of industrial production in plateau.

The method and the system according to the invention are further described with reference to lithium carbonate extracted from the salt lakes hereinafter.

A high-efficiency heat energy recycling method for extracting lithium carbonate includes the steps as follows:

1) a concentrated solar photo-thermal device is utilized to heat the heat-transfer oil to more than 200° C. for standby;
2) the water in the hot end of the water tank is heated up to above 80° C. via the solar photo-thermal device and the optional auxiliary electric heating device, and the bittern in the preheating pool is preheated, and the preheated bittern is guided into the temperature rising kettle;
3) The hot water in the hot end of the water tank is circulated and guided in a heat exchange coil in the temperature rising kettle, and the bittern in the temperature rising kettle is heated up to above 70° C.;
4) the bittern at the temperature above 70° C. in the temperature rising kettle is guided into the reaction kettle, vacuumized for decompressed concentration, at the same time the heated heat-transfer oil is guided into a heat exchanger in the reaction kettle to rapidly, additionally heat the reaction kettle to ensure the bittern may be continuously and rapidly boiled and rapidly evaporated and concentrated; the vapor produced by decompressing concentration is guided into the heat exchanger in the preheating pool to cool, the released heat firstly heats a second-level preheating pool (high temperature), the condensed hot water is guided into the heat exchanger of a first-level preheating pool (low temperature), in this way, a higher temperature difference remains between the bittern and the vapor (hot water) via heat exchange of countercurrent flow, which may not only effectively preheat the bittern in the second-level preheating temperature, but also may sufficiently recycle the latent heat in the vapor; and distilled water obtained is collected into a distillate tank for standby;
5) high temperature supernatant crystallized in the reaction kettle is guided into a cold end crystallization kettle via a pipeline, a liquid heat conducting medium in the cold end of the water tank is guided into the heat exchange coil in the cold end crystallization kettle, the high temperature supernatant in the cold end crystallization kettle is cooled, the salt in the supernatant is saturated and crystallized to obtain K, Na salts; the cooled and crystallized normal temperature or low temperature supernatant is guided into a supernatant sedimentation tank to perform further recycling or compensate into the salt lakes, which reduces the damage to the salt lake ecology;
6) the distilled water is heated with the heat-transfer oil, coarse crystallized salts of lithium carbonate deposited in the reaction kettle are scoured by using the heated distilled water to dissolve K, Na salts therein, the scouring liquor is collected and guided into a scouring liquor thermal insulation kettle, and kept warm to deposit, which further recycles the lithium carbonate therein; and the lithium carbonate crystals in the reaction kettle are collected and dried;
7) after the device runs for a period of time, the device and the pipeline of the system which are contacted with the bittern are flushed by using the heated distilled water or the supernatant in the scouring liquor thermal insulation kettle to flush salt scales produced by long-term running in the pipeline, the reaction kettle and the scouring liquor thermal insulation kettle, and the flushing liquor is returned to the lakes after recycling the heat energy in the flushing liquor.

According to the above-mentioned production process, the concentration and crystallization of a batch of bittern may be finished within about 1-2 hours, and the concentration and crystallization of a batch of bittern may be finished within about 10-30 minutes in a condition that the heat quantity is sufficient at noon. By calculating the working hours of 8-10 hours per day, the concentration and crystallization of several batches of bittern may be finished in the same day, the collected and obtained lithium carbonate may be unified and centralized in the scouring liquor thermal insulation kettle to keep warm and stay overnight, and the subsequent treatment is continued after the crystal growth to obtain the lithium carbonate crystals with the purification more than 90%, so that the traditional production process of “living depending on the weather” is totally broken away.

The heat energy recycling method and system according to the invention, near 60-70% of heat energy may be recycled from the system, and the installed capacity of a matched solar photovoltaic power generating station may be reduced to 25-33% of the original installed capacity, which greatly reduces the fixed investment.

The test data indicate that a concentrated solar photo-thermal device is adopted in the plateau areas at the altitude of above 3,700 meters to generally achieve a temperature of above 100° C. at about 10:00 AM until at about 18:30 PM, the temperature may still be protected above 120° C., which may totally achieve the industrial production, so that the existing production process in the salt lakes may be completely changed.

A high temperature concentrated solar thermal collector according to the invention is further described with reference to the drawings hereinafter.

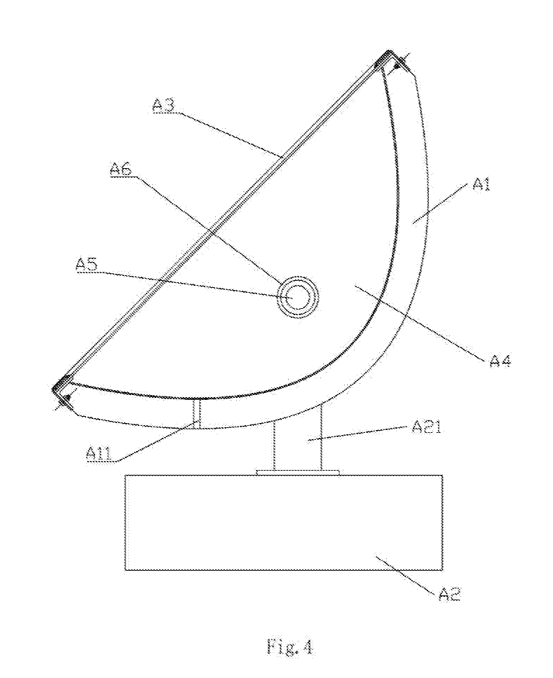

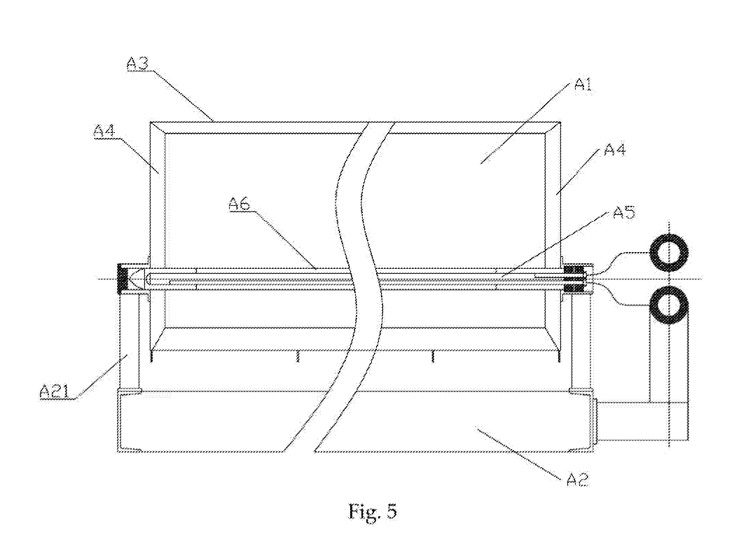

As shown in FIG. 4 and FIG. 5, the concentrated solar photo-thermal device includes a cambered concentrated light reflecting board A1 and a support A2 for fixing the reflecting board A1, a light transmitting board A3 fixed on the front of the light reflecting board A1, end boards A4 arranged at both ends of the light reflecting board A1, the light reflecting board A1, the light transmitting board A3 and the end boards A4 jointly forming a cavity, a collector pipe A5 arranged in the cavity along the parallel direction, and the collector pipe A5 internally provided with a liquid inlet and a liquid outlet.

The cambered concentrated light reflecting plate is wholly groove-like, and the so-called parallel direction is the axis direction of the light reflecting board. In this way, the sunshine irradiated from different angles may be focused on one line, without frequently regulating the angle of the light reflecting board, which is beneficial for reducing the device maintenance.

As a further improvement of the invention, the collector pipe A5 of the thermal collector is sheathed with a transparent thermal insulation pipe A6 so the light can come through the thermal insulation pipe and the air circulation is obstructed. This may further reduce the heat exchange between the collector pipe and the outside environment, so that the photo-thermal conversion efficiency is improved.

As a further improvement of the invention, the surface of the collector pipe of the thermal collector is black. The black surface may more sufficiently absorb all kinds of lights, so that the photo-thermal conversion efficiency is improved.

As a further improvement of the invention, the thermal insulation pipe of the thermal collector is a double-layer vacuum glass pipe. The double-layer vacuum glass pipe has better transparency and thermal insulation performance, which is more beneficial for improving the photo-thermal conversion efficiency.

As a further improvement of the invention, the surface of the collector pipe of the thermal collector is a matte surface. The matte surface may further reduce the reflection of light, so as to improve the photo-thermal conversion efficiency.

As a further improvement of the invention, the support A2 in the thermal collector is provided with a revolving shaft A21 for regulating the light reflecting board A1 to rotate, which is convenient to regulate in a condition that the shining angle of the sun is changed greatly.

As a further improvement of the invention, the revolving shaft of the thermal collector is provided with an angle gauge, thereby facilitating regulation rapidly and accurately.

As a further improvement of the invention, the high temperature concentrated solar thermal collector in the thermal collector is provided with an actuator for driving the revolving shaft to rotate, so as to be beneficial to automatic regulation and control.

As a further improvement of the invention, the bottom of the light reflecting board in the thermal collector is provided with a liquid outlet A11, which may not only balance the pressure in and out of the cavity, but also may avoid accumulating water in the cavity.

As a further improvement of the invention, the surface of the light transmitting board of the thermal collector is provided with anti-static coating or an electric conduction layer A31, which removes the static electricity on the surface, and prevents the surface from absorbing dust to affect the transparency.

The heat conducting liquid is guided in via the liquid inlet and guided out via the liquid outlet when used. If necessary, several thermal collectors may be connected in series to obtain a higher temperature, and the temperature of the heat conducting liquid may also be regulated by regulating the liquid feeding speed. It is convenient to obtain the temperature required.

What is claimed is:

1. A high-efficiency heat energy recycling method, comprising:
(a) utilizing a concentrated solar photo-thermal device to heat heat-transfer oil to more than 120° C. for standby;
(b) heating a liquid heat conducting medium in a water tank hot end and bittern in a preheating pool via the solar photo-thermal device, and guiding the preheated bittern into a temperature rising kettle;
(c) absorbing heat from the water tank cold end via a high temperature heat pump, releasing heat to the temperature rising kettle via the hot end of the water tank, and heating the bittern in the temperature rising kettle to the temperature required;
(d) guiding the bittern in the temperature rising kettle into a reaction kettle, vacuumizing for decompressing concentration, guiding the heated heat-transfer oil into a heat exchanger in the reaction kettle to rapidly and additionally heat the reaction kettle, guiding the vapor produced by decompressing concentration in the reaction kettle into the heat exchanger in the preheating pool for cooling, and collecting the distilled water obtained into a distillate tank;
(e) guiding the high temperature supernatant after crystallization in the reaction kettle into a cold end crystallization kettle via a pipeline, performing heat exchange between the water tank cold end and the cold end crystallization kettle via the heat exchanger, cooling the high-temperature supernatant, and guiding the cooled and crystallized normal-temperature or low-temperature supernatant into a supernatant sedimentation tank;
(f) heating the distilled water with the heat-transfer oil, scouring coarse crystallized salts in the reaction kettle, and guiding high-temperature scouring liquor into a scouring liquor thermal insulation kettle; and
(g) optionally, flushing the device and the pipeline of the system which are contacted with the bittern using the heated distilled water or the hot scouring liquor after sedimentation in necessity.

2. The high-efficiency heat energy recycling method according to claim 1, wherein the liquid heat conducting medium at the water tank cold end and the hot end of the water tank is water or heat-transfer oil independently.

3. A high-efficiency heat energy recycling system applicable to plateau areas, comprising a preheating pool, a temperature rising kettle, a reaction kettle, a cold end crystallization kettle, a scouring liquor thermal insulation kettle and a supernatant sedimentation tank, wherein the preheating pool, the temperature rising kettle, the reaction kettle, the cold end crystallization kettle and a distillate tank are all provided with a heat exchanger, the scouring liquid thermal insulation kettle is internally provided with a thermostat; the preheating pool is provided with a pipeline connecting to the temperature rising kettle, the temperature rising kettle is provided with a pipeline connecting to the reaction kettle, the reaction kettle is provided with a pipeline connecting to the cold end crystallization kettle and the scouring liquor thermal insulation kettle, the cold end crystallization kettle is provided with a pipeline connecting to the supernatant sedimentation tank, wherein:
the system is further provided with a heat-transfer oil tank, the heat-transfer oil tank is connected with a concentrated solar photo-thermal device for heating heat-transfer oil, and a closed heat-transfer oil pipeline connecting to the heat exchanger in the reaction kettle and the heat exchanger in the distillate tank;
the hot end of the water tank and the preheating pool are connected with a solar photo-thermal device for supplying heat thereto;
a high-temperature heat pump is arranged between the hot end of the water tank and the water tank cold end, the heat exchanger is arranged between the hot end of the water tank and the temperature rising kettle; and the heat exchanger is arranged between the water tank cold end and the cold end crystallization kettle; and
the reaction kettle is connected with a vacuum device, the vacuum device is provided with a heat exchanger guiding vapor into the preheating pool and a pipeline extending to the distillate tank; and the distillate tank is provided with a pipeline guiding the distilled water into the reaction kettle and the scouring liquor thermal insulating kettle.

4. The high-efficiency heat energy recycling system according to claim 3, wherein the preheating pool comprises at least two preheating pools connected in series.

5. The high-efficiency heat energy recycling system according to claim 3, wherein the hot end of the water tank is connected with an auxiliary heating device.

6. The high-efficiency heat energy recycling system according to claim 3, wherein the high temperature heat pump is provided with:
a multipoint thermal balance heat exchanger generating hot water via heat exchange, wherein the multipoint thermal balance heat exchanger is provided with a cold water input end, and hot water output from an output end is accessed to the hot end of the water tank through a water pump and a check valve;
a heat pump compressor, wherein coolants compressed and output by the heat pump compressor are provided for the multipoint thermal balance heat exchanger through an evaporator and a throttle in sequence, and the coolants are output from the multipoint thermal balance heat exchanger and then are inhaled by the heat pump compressor for circulation; and
the multipoint thermal balance heat exchanger comprises a plurality of groups of heat exchangers connected in series, and a cross runner is arranged among various groups of heat exchangers.

7. The high-efficiency heat energy recycling system according to claim 6, wherein the hot water output end of the multipoint thermal balance heat exchanger is provided with a temperature control valve, and the output of the temperature control valve is connected with the water pump.

8. The high-efficiency heat energy recycling system according to claim 6, wherein a vapor-liquid separator is arranged between the heat pump compressor and the evaporator.

9. The high-efficiency heat energy recycling system according to claim 6, wherein the cold water input end of the multipoint thermal balance heat exchanger is provided with a dirt remover.

10. The high-efficiency heat energy recycling system according to claim 6, wherein the coolants used for the high temperature heat pump are ternary composite coolants with a mass ratio of R124:R245a:R22=3:3:1.

11. The high-efficiency heat energy recycling system according to claim 3, wherein the concentrated solar photo-thermal device is a high-temperature concentrated solar thermal collector, comprising a cambered concentrated light reflecting board and a support for fixing the reflecting board, a light transmitting board is fixed on the front of the light reflecting board, end boards are arranged at both ends of the light reflecting board, the light reflecting board, the light transmitting board and the end boards jointly form a cavity, a collector pipe is arranged in the cavity along the parallel direction, and the collector pipe is internally provided with a liquid inlet and a liquid outlet.

12. The high-efficiency heat energy recycling system according to claim 11, wherein the collector pipe of the high temperature concentrated solar thermal collector is sheathed with a transparent thermal insulation pipe.

13. The high-efficiency heat energy recycling system according to claim 11, wherein the surface of the collector pipe of the high temperature concentrated solar thermal collector is black.

14. The high-efficiency heat energy recycling system according to claim 11, wherein the surface of the collector pipe of the high temperature concentrated solar thermal collector is a matte surface.

15. The high-efficiency heat energy recycling system according to claim 11, wherein the thermal insulation pipe of the high temperature concentrated solar thermal collector is a double-layer vacuum glass pipe.

16. The high-efficiency heat energy recycling system according to claim 11, wherein the support of the high temperature concentrated solar thermal collector is provided with a revolving shaft for regulating the light reflecting board to rotate.

17. The high-efficiency heat energy recycling system according to claim 11, wherein the revolving shaft of the high temperature concentrated solar thermal collector is provided with an angle gauge.

18. The high-efficiency heat energy recycling system according to claim 16, wherein the high temperature concentrated solar thermal collector is provided with an actuator for driving the revolving shaft to rotate.

19. The high-efficiency heat energy recycling system according to claim 11, wherein the bottom of the light reflecting board of the high temperature concentrated solar thermal collector is provided with a liquid outlet.

20. The high-efficiency heat energy recycling system according to claim 11, wherein the surface of the light transmitting board of the high temperature concentrated solar thermal collector is provided with anti-static coating or a conducting layer.
